(19) United States
(12) Patent Application Publication
(10) Pub. No.: US 2009/0142648 A1
(43) Pub. Date: Jun. 4, 2009

(54) Thin film glass composite catalyst electrode

(75) Inventors: Paul A. Kohl, Atlanta, GA (US); William E. Mustain, Manchester, CT (US); Shruti Prakash, Atlanta, GA (US); Hyea Kim, Atlanta, GA (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: Georgia Tech Research Corporation, Atlanta, CA (US)

(21) Appl. No.: 12/288,587

(22) Filed: Oct. 22, 2008

Related U.S. Application Data
(60) Provisional application No. 60/981,595, filed on Oct. 22, 2007.

(51) Int. Cl. H01M 4/92

(52) U.S. Cl. 429/41; 205/109

(57) ABSTRACT

The present disclosure relates to a glass composite catalyst electrode comprising a glass matrix and metal particles incorporated into the glass matrix. The present disclosure also relates to a method for composing a glass composite catalyst electrode. A glass composite catalyst electrode is a porous homogeneous structure with an approximately uniform distribution of metal particles. The metal particles are operable to catalyze reactions in the fuel cell. Conductive material, which may also be operable to catalyze reactions in the fuel cell, may be deposited on the glass composite catalyst electrode in order to increase the electrical conductivity of the glass composite catalyst electrode and to increase the electrochemically active area of the glass composite catalyst electrode.

### RELATED APPLICATIONS

This application claims the benefit under 35 U.S.C. § 119(e) of U.S. Provisional Patent Application No. 60/981,595, titled “THIN FILM PT AND PT-RU GLASS COMPOSITE CATALYST,” filed Oct. 22, 2007, which is incorporated by reference in its entirety.

### FEDERALLY SPONSORED RESEARCH OR DEVELOPMENT

This invention was made with U.S. Government support under contract no. N66604-06-C-2330 awarded by the U.S. Department of Defense, Department of the Navy. The U.S. Government has certain rights in this invention.

### BRIEF DESCRIPTION OF THE DRAWINGS

Non-limiting and non-exhaustive embodiments of the disclosure are described, including various embodiments of the disclosure with reference to the figures, in which:

FIG. 1 is a cross-sectional view of a proton exchange membrane fuel cell.

FIG. 2A and FIG. 2B are cross-sectional views of a conceptual embodiment of a glass composite catalyst electrode at two points in a method of production.

FIG. 3A is a cross-sectional view of a conceptual embodiment of a glass composite catalyst electrode serving as an anode in a membrane electrode assembly.

FIG. 3B is a cross-sectional view of a conceptual embodiment of a first glass composite catalyst electrode serving as an anode and a second glass composite catalyst electrode serving as a cathode in a membrane electrode assembly.

FIG. 4 shows a scanning electron micrograph at 11,000 times magnification of an experimental glass composite catalyst electrode produced, as described in Example 1.

FIG. 5A shows a scanning electron micrograph at 32,000 times magnification of an experimental glass composite catalyst electrode produced, as described in Example 1.

FIG. 5B shows a backscatter scanning electron micrograph at 32,000 times magnification of an experimental glass composite catalyst electrode produced, as described in Example 1.

FIG. 6A shows a plot of time an experimental glass composite catalyst electrode is exposed to a plating bath versus the deposited mass of platinum per square centimeter.

FIG. 6B shows a plot of the deposited mass of platinum per square centimeter on an experimental glass composite catalyst electrode versus electrical resistance per square centimeter.

FIG. 7A shows a scanning electron micrograph at 50,000 times magnification of an experimental glass composite catalyst electrode before electroless deposition of platinum in a plating bath.

FIG. 7B shows a scanning electron micrograph at 50,000 times magnification of an experimental glass composite catalyst electrode after 180 seconds of electroless deposition of platinum in a plating bath.

FIG. 7C shows a scanning electron micrograph at 50,000 times magnification of an experimental glass composite catalyst electrode after 300 seconds of electroless deposition of platinum in a plating bath.

FIG. 7D shows a scanning electron micrograph at 50,000 times magnification of an experimental glass composite catalyst electrode after 1800 seconds of electroless deposition of platinum in a plating bath.

FIG. 8 shows a cyclic voltammogram plot of an experimental glass composite catalyst electrode after 300 seconds of electroless deposition of platinum in a plating bath in 0.5 M H₂SO₄ before and after the addition of methanol.

FIG. 9 shows a comparison of the polarization curves of a passive micro-direct methanol fuel cell comprising conventional perflourinated sulfonic acid polymer catalyst layers and an experimental passive micro-direct methanol fuel cell comprising a glass composite catalyst electrode.

### DETAILED DESCRIPTION OF THE EMBODIMENTS

The embodiments of the disclosure will be best understood by reference to the drawings, wherein like parts are designated by like numerals throughout. It will be readily understood that the components of the embodiments, as generally described and illustrated in the figures herein, could be arranged and designed in a wide variety of different configurations. Thus, the following more detailed description of various embodiments, as represented in the Figures, is not intended to limit the claim scope, but is merely representative of various embodiments of the disclosure. While the various aspects of the embodiments are presented in drawings, the drawings are not necessarily drawn to scale unless specifically indicated.

A fuel cell is an electrochemical energy conversion device that produces electricity from a fuel. Small fuel cells are attractive power sources for a variety of low-power applications with electrical current requirements ranging between a few microamps to about 30 milliamps and power requirements between 1 μW and 1,000 μW. Larger power requirements may be satisfied by using a plurality of fuel cells in combination. Applications for small fuel cells may include, but are not limited to: electronic battery replacements, wireless sensors (including temperature sensors, pressure sensors, active RFID tags, and the like), meter readers (including water and gas meter readers), fire alarms, and a wide variety of consumer electronic devices (including cellular telephones, mobile computers, and the like). An application benefiting from a high energy-density and modest but steady power density is one where state-of-the-art batteries are challenged, but where small fuel cells are well suited. Liquid methanol based fuel cells, for example, provide high volumetric power density up to 20 times that of Li-ion.

In a typical fuel cell the anode and cathode are separated by a proton-exchange membrane (PEM). The assembly comprising the cathode, PEM, and anode may be referred to as a membrane electrode assembly (MEA). The PEM 130 may comprise any proton conducting electrolyte, including the perflourinated sulfonic acid polymer commercially available under the registered trademark Nafion from DuPont Chemical Co. Other commercially available proton conducting electrolytes include, but are not limited to: Hyflon from Dow Chemical Company, Flemion from Asahi Glass company, Aciplex-S from Asahi Glass Company, Neosepta-F from Tokuyama Corporation, Gore Select from W. L. Gore & Associates, polystyrene sulfonic acid, poly (vinyl alcohol)-poly (2-acrylamido-2-methyl-1-propanesulfonic acid), poly ether ether ketone, sulfonate poly ether ether ketone, sulfonated poly phenylene oxide, polybenzimidazole, polyimides, P2O5-ZrO2-SiO2 glass, and P2O5-TiO2SiO2 glass.

Perfluorsulfonic acid based electrolytes have high methanol permeability, and the performance of these electrolytes is strongly tied to temperature and water content. The dependence on water content may lead to inconsistent ionic conductivity over various physical conditions. Further, the efficiency of a direct methanol fuel cell (DMFC) and cells using other types of fuels is lowered by fuel cross over. Fuel cross over refers to fuel reaching the cathode and oxidizing. The electrons resulting from the oxidation reaction at the cathode do not follow the current path between the electrodes, and thus, reduce the efficiency of the cell. In addition to lowering the efficiency of the cell in operation, fuel cross over wastes fuel, even when the cell is not in use.

In order to address both the performance limitations and the methanol crossover of perfluorsulfonic acid based electrolytes for small, low-power fuel cells, phosphorous-doped (P-doped) glass electrolytes have been fabricated. Additional information regarding glass electrolytes is available in Christopher W. Moore, Jun Li & Paul A. Kohl, Microfabricated Fuel Cells with Thin-Film Silicon Dioxide Proton Exchange Membranes, 152 (8) J. OF THE ELECTROCHEMICAL SOC. A1606 (2005); J. Li, C. Moore, D. Bhusari, S. Prakash, & P. Kohl, Microfabricated Fuel Cell with Composite Glass/Nafion Proton Exchange Membrane, 153 (2) J. OF THE ELECTROCHEMICAL SOC. A343 (2006); and International Publication Number WO 2007/070399 A2.

P-doped glass electrolytes have lower ionic conductivity when compared to perfluorsulfonic acid based electrolytes; however, in low current systems reducing fuel cross over may have a greater effect on the overall performance of the fuel cell. For example, the permeability coefficient of 3 MPS-GPTMS composite glass is on the order of four orders of magnitude less than Nafion. Other glass forming compounds may also be used, such as alkoxy silane (e.g. methoxy silane, ethoxy silane, epoxy silane) and the like. Modest current density and micrometer-scale thickness lessens the total electrolyte ionic resistance, and may reduce the energy loss due to ionic transport. Accordingly, in applications where the cell may need to operate for a long period of time (e.g. 1 year or more), a glass electrolyte may exhibit better long-term performance in spite of lower ionic conductivity.

Performance of glass electrolytes has also been limited due to swelling caused by a coefficient of thermal expansion mismatch between perfluorsulfonic acid based catalyst layers and the glass electrolyte. The swelling may result in stress, cracking, and loss of conductivity.

A glass composite catalyst electrode, as described in greater detail below, may reduce methanol crossover by acting as a barrier between the methanol and the PEM. Further, a glass composite catalyst electrode, as described in greater detail below, may also avoid the problem of mismatched coefficients of thermal expansion.

A glass composite catalyst electrode according to the present disclosure relates generally to proton-exchange fuel cells, including hydrogen fuel cells, direct methanol fuel cells, direct ethanol fuel cells, formic acid fuel cells, and the like. As the names imply, one of the two redox processes in these fuel cells is fueled by hydrogen, methanol, ethanol, and formic acid, respectively. Other fuels may also be used in proton-exchange fuel cells, including but not limited to: butanol, glycols, diglycols such as ethylene diglycol, organic acids such as formic acids, acetic acids, and aldehydes such as formaldehyde. The specific embodiments discussed below relate generally to DMFCs; however, the teachings are more generally applicable to proton-exchange fuel cells utilizing any liquid fuel, including, but not limited to, the fuels listed above.

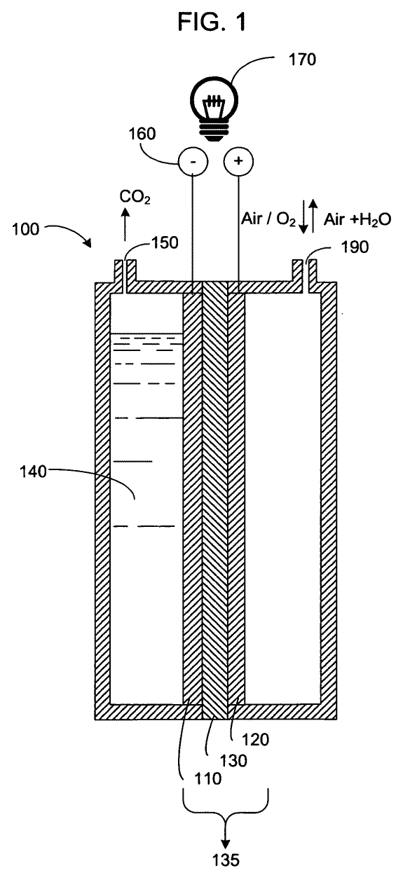

With reference to the accompanying figures, particular embodiments will now be described in greater detail. Referring to FIG. 1, a fuel cell 100 may include an anode 110 and a cathode 120 separated by a PEM 130. The anode 110 may be disposed on one side of the PEM 130 and the cathode 120 may be disposed on the opposite side of the PEM 130. The assembly comprising the cathode 120, PEM 130, and anode 110 may be referred to as a membrane electrode assembly (MEA) 135.

In operation, a fuel 140, such as liquid methanol, is oxidized at the anode 110, in the presence of a catalyst, (e.g. Pt—Ru) and water (H₂O), to produce electrons (e⁻), hydrogen cations (H⁺), and carbon dioxide (CO₂). In a DMFC, the anode and cathode reactions in a DMFC can be expressed as follows:

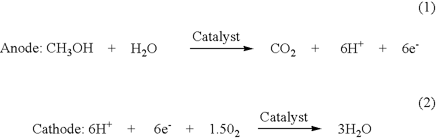

The fuel cell 100 may include a vent 150 to allow the escape of reaction gasses, such as CO₂. The electrons flow from the anode 110 to the cathode 120 through an external circuit 160 electrically connected between the anode 110 and the cathode 120. The external circuit 160 delivers electrical energy to an attached electrical device or storage device 170. Hydrogen cations (H⁺) pass through the PEM 130 and combine with oxygen (O₂), in the presence of a catalyst, to form water at the cathode 120.

The vent 190 may allow air from the environment to enter the cathode chamber and provide the oxygen required for the reaction at the cathode 120. The vent 190 may also allow air and water to exit the cathode chamber.

In a conventional fuel cell, a catalyst layer and a current collecting layer may be applied to the anode 110 and the cathode 120 of the PEM 130. Perflourinated sulfonic acid based polymers have been used in the preparation of conventional catalyst layers and catalyst inks. Traditional catalyst layers may have been deposited onto conductive carbon cloth or paper. The electrons liberated in the reaction at the anode 110 may be collected using the conductive carbon cloth, which may be connected to the external circuit 160.

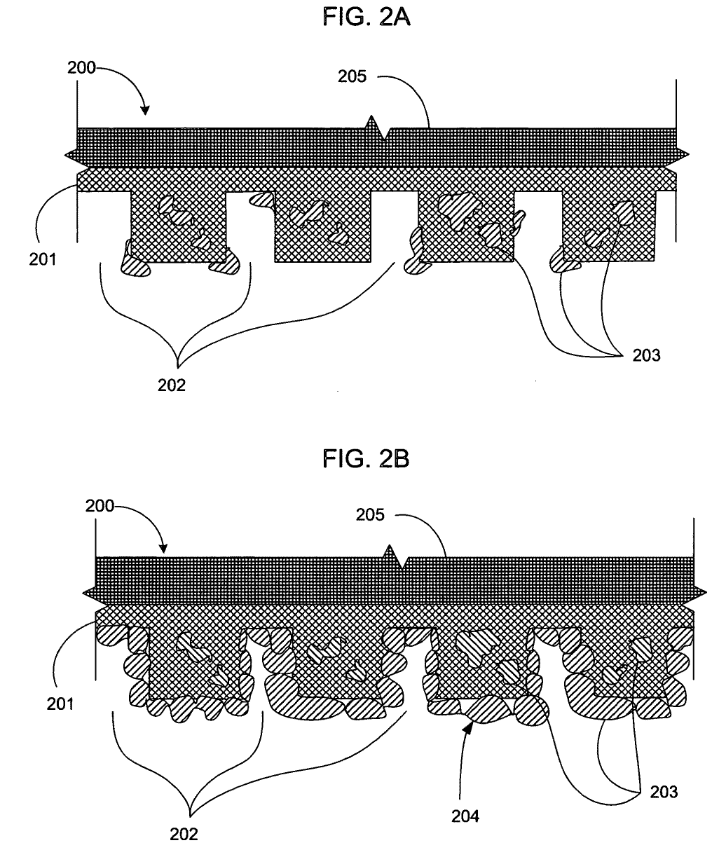

FIG. 2A and FIG. 2B are cross-sectional views of a conceptual embodiment of a glass composite catalyst electrode 200 at two points in a method of production. FIG. 2A shows a glass matrix 201 incorporating a plurality of pores 202. The glass matrix 201 is disposed on a substrate 205. A plurality of metal particles 203 are disposed within the glass matrix 201. As illustrated, some metal particles 203 may be disposed along the surface of the glass matrix 201, while other metal particles 203 may be incorporated three-dimensionally within the glass matrix 201.

The glass matrix 201 illustrated in FIG. 2A may be the result of a reaction between a silicon precursor, such as tetraethyl orthosilicate, and deionized water in a sol-gel type hydrolysis. Methanol may be used as a solvent and mixing agent in the reaction. In some embodiments, phosphorus may be added to increase the ionic conductivity in the resulting glass matrix 201. In such embodiments, phosphorous oxide and P—OH structures within the glass matrix 201 contribute to proton conductivity. The phosphorous oxide adds to the free volume of the glass because it has a different molecular size than glass. The metal particles 203 may be embodied as carbon supported platinum particles, platinum-ruthenium alloy particles, nickel particles, silver particles, copper particles, aluminum particles, or any other suitable material for catalyzing a reaction with a fuel. In certain embodiments, the metal particles may have a size on the order of nanometers. Metal particles having a size on the order of nanometers are desirable because a high surface area is desirable; however, the metal particles may have a larger size, for example, on the order of micrometers. The metal particles 203 may be introduced during the hydrolysis reaction under vigorous agitation in order to ensure a uniform distribution within the glass matrix 201.

The sol reaction may proceed for some time and may then be deposited onto a substrate, using, for example, the doctor-blade method. The product of the sol reaction that is deposited onto the substrate 205 may be described as a glass matrix film. The substrate 205 may then be subjected to one or more curing steps to evaporate the solution and complete the reaction. In some embodiments, the substrate 205 may comprises fiberglass cloth. A long cure time, such as two days, may yield acceptable results; however, shorter cure times may also be acceptable. In certain embodiments, the resulting glass matrix 201 may have a thickness between approximately 0.3 μm and 0.66 μm, and a mean pore size of approximately 1 μm.

As illustrated in FIG. 2A, the metal particles 203 deposited in the glass matrix 201 may be separated by relatively large distances. Glass is an electrical insulator, and accordingly, the glass matrix 201, shown in FIG. 2A, may exhibit a high electrical resistance. If the glass composite catalyst electrode 200 is also used as a current collector, the electrical resistance of the current collector is preferably low, so as to minimize energy loss due to electrical resistance. In order to decrease electrical resistance, additional conductive material may be deposited on the surface of the glass matrix 201.

FIG. 2B shows that additional conductive material has been added to form an electrically conductive layer 204, comprised, at least in part, of the metal particles 203 that are incorporated into the glass matrix 201. Additional conductive material may be deposited on the glass matrix 201 using a secondary method, such as electro and electroless deposition, direct current sputtering, alternating current sputtering, thermal evaporation, and electron beam evaporation, and the like.

One method of electroless deposition of a conductive material is an aqueous plating bath. The aqueous plating bath will readily deposit additional conductive material on the metal particles 203, causing the metal particles 203 to grow and fill the electrically insulating gaps separating the conductive metal particles 203. As illustrated, the additional conductive material may facilitate the coalescence of individual metal particles 203 into an electrically conductive layer 204 that is capable of collecting and carrying a current over the entire length of the glass composite catalyst electrode 200. The metal particles 203 that are deeply embedded in the glass matrix 201, and which grow with the deposition of the additional conductive material, securely adhere the electrically conductive layer 204 to the glass matrix 201.

In certain embodiments, the additional conductive material may also be catalytic material, which may serve to both increase the electrical conductivity and to increase the electrochemically active area of the glass composite catalyst electrode 200.

While the deposition of additional conductive material may reduce electrical loses in the current collector, depositing too much conductive material may close the pores 202 in the glass matrix 201. The pores 202 may provide pathways for supplying fuel to, and transporting products away from electrochemically active areas. Accordingly, closing the pores 202 may negatively affect the performance of the fuel cell. There may be a trade-off between adding additional conductive material in order to decrease the electrical resistance of the electrically conductive layer 204, and maintaining a highly porous glass composite catalyst electrode 200. In one embodiment, after the deposition of additional conductive material the glass composite catalyst electrode 200 has an electrical resistance of less than 100 Ω per centimeter, a mean pore size of approximately 80 nanometers and comprises between approximately 1 milligram and 3 milligrams of platinum per square centimeter.

In some embodiments, it may not be necessary to use a secondary method to deposit additional conductive material in order to form the electrically conductive layer 204. A sufficient quantity of metal particles 203 may be introduced during the sol-gel hydrolysis reaction to ensure a sufficiently low electrical resistance. In such an embodiment, the metal particles 203 may form the electrically conductive layer 204. Such embodiments may benefit from a simplified manufacturing process by avoiding the deposition of additional conductive material by secondary methods. On the other hand, however, catalyst utilization in such embodiments may be lower because not all of the metal particles 203 will be disposed on the surface of the glass matrix 201, where the metal particles 203 are able to catalyze reactions with the fuel in the fuel cell. In practice the pores 202 may not exhibit the uniform shape, size, and spacing of the pores 202 illustrated in the conceptual embodiment shown in FIGS. 2A and 2B.

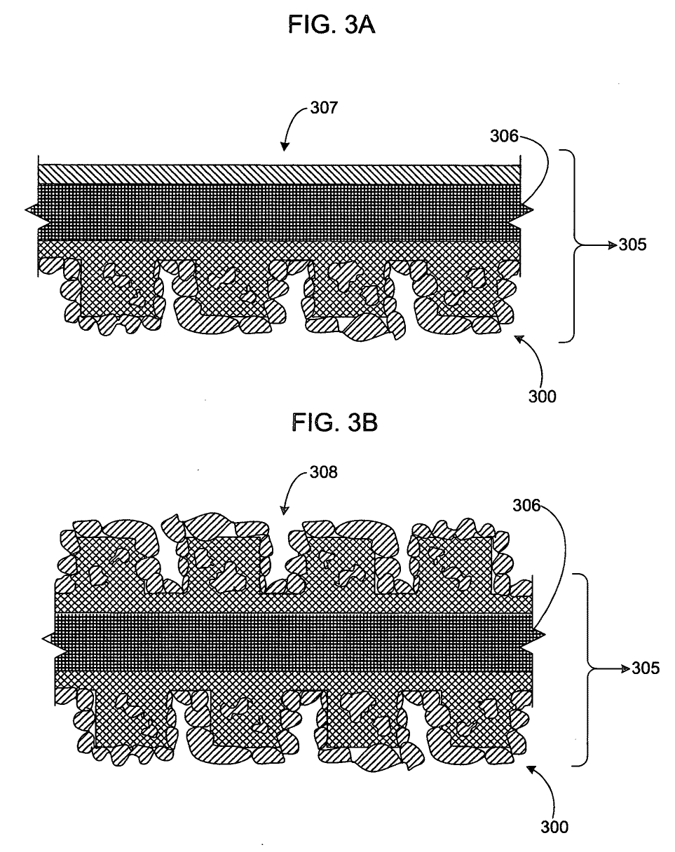

FIG. 3A is a conceptual view of a glass composite catalyst electrode 300 incorporated into a membrane electrode assembly 305. The glass composite catalyst electrode 300 has been deposited on a porous frit based composite PEM 306. The porous frit based composite PEM 306 may be fabricated in accordance with the disclosure of International Publication Number WO 2007/070399 A2, which is incorporated herein by reference. The glass composite catalyst electrode 300 may serve as an anode. A cathode 307 may be disposed on the opposite side of the composite PEM 306 from the glass composite catalyst electrode 300. The membrane electrode assembly 305 may be incorporated into a fuel cell. In the embodiment illustrated in FIG. 3B, a second glass composite catalyst electrode 308 may also serve as the cathode in the membrane electrode assembly 305. The embodiment illustrated in FIG. 3B may benefit from improved adhesion between the PEM 306, and the glass composite catalysts electrodes 300, 306.

### Example 1

An experimental embodiment of a glass composite catalyst electrode was prepared, and its proprieties were investigated experimentally. Commercially available carbon-supported platinum nanoparticles (available from E-Tek) were incorporated into a glass matrix. The glass matrix was prepared by a sol-gel hydrolysis reaction between tetraethyl orthosiicate (TEOS) and deionized water in the presence of methanol in a 1:3:7 molar ratio. Phosphorus was added (P₂O₅) so that the silicon-phosphorus atomic ratio was 19:1. During the hydrolysis reaction, the carbon supported platinum nanoparticles were introduced to the system under vigorous agitation. In Example 1, the ratio of the carbon supported platinum nanoparticles to TEOS was approximately one to four. The sol reaction was allowed to proceed for 30 minutes, and was deposited onto a 1 millimeter thick, 2.0 square centimeter, Nafion-impregnated porous glass frit (available from Ace Glass). The sol reaction was deposited on the porous glass frit by the doctor-blade method and was exposed to three curing steps of fifteen minutes each, at temperatures of 75° C., 150° C., and 275° C., respectively. During the curing steps, the solvent was evaporated and the reaction was completed.

The porous glass frit was prepared by soaking the porous glass frit in Nafion dispersion (DE 520, available from DuPont) for 30 minutes and exposing it to a 150° C. curing step for 90 minutes. The process was repeated 10 times in order to fill a sufficient amount of the void space in the porous glass frit with the polymer electrolyte.

Experimental Results of Example 1

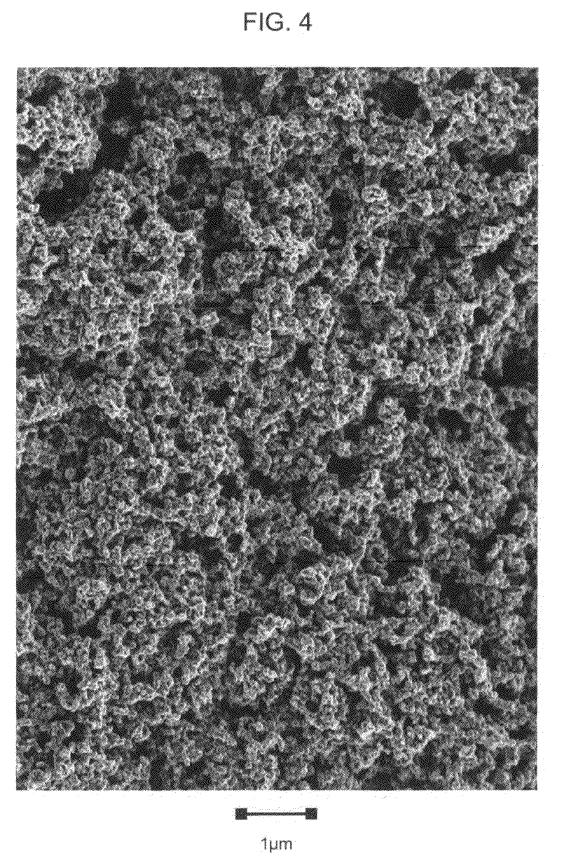

FIG. 4 is a SEM micrograph at 11,000 times magnification of an experimental glass composite catalyst electrode produced as described in Experiment 1. As illustrated by FIG. 4, the surface of the experimental glass composite catalyst electrode is highly porous, with an average pore size of approximately 150 nanometers. FIG. 4 illustrates that the experimental glass composite catalyst electrode had a uniform distribution of the platinum nanoparticles. The glass matrix film also showed excellent adhesion to the glass substrate, and it was resistant to scratching and flaking, indicating that the sol-gel glass was well bonded to the glass substrate. The glass matrix film thickness was 1.9±0.2 μm. Comparing FIG. 4 to the conceptual embodiments illustrated in FIGS. 2A, 2B, 3A, and 3B, FIG. 4 illustrates that in practice the pores may not exhibit the uniform shape, size, and spacing of the pores 202 illustrated in the conceptual embodiments.

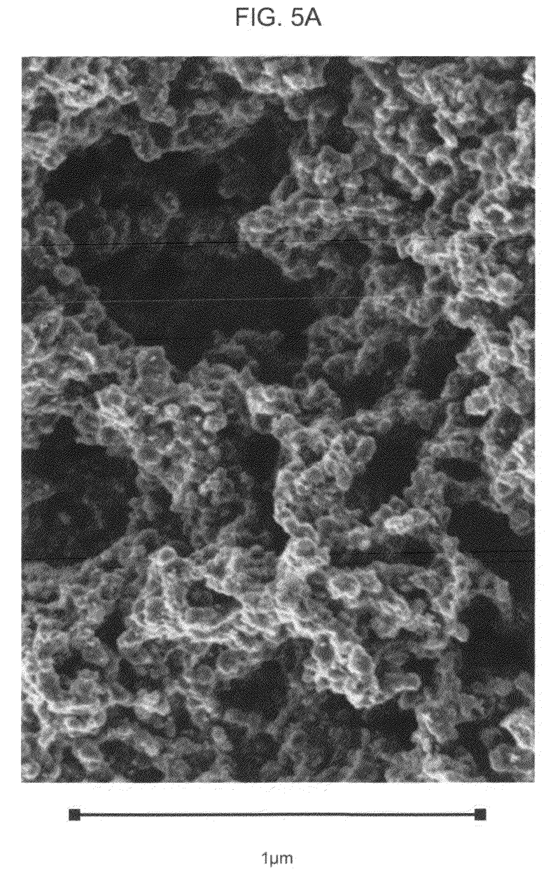

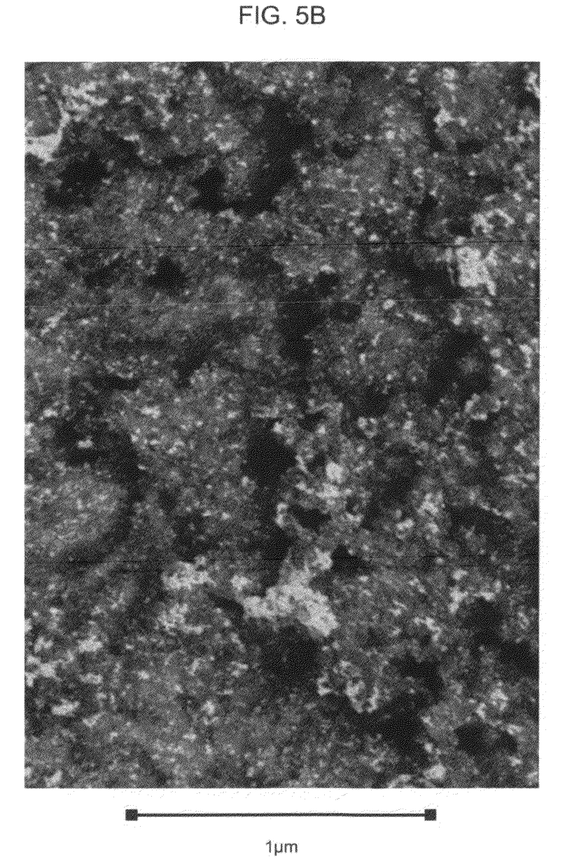

FIG. 5A shows a SEM micrograph at 32,000 times magnification of an experimental glass composite catalyst electrode produced as described in Example 1. FIG. 5B shows a backscatter SEM micrograph at 32,000 times magnification of the glass matrix film. The bright spots in FIG. 5B show the platinum nanoparticles within the glass matrix. Some of the platinum nanoparticles shown in FIG. 5A and FIG. 5B are over 100 nanometers in diameter, although most of the platinum nanoparticles have diameters of approximately 5 nanometers. Many of the platinum nanoparticles are separated by approximately 25 nanometers of glass.

The electrical characteristics of the experimental glass composite catalyst electrode shown in FIG. 5A were also examined. Electrical resistance measurements taken of the surface of the experimental glass composite catalyst electrode were in excess of 5000Ω per centimeter. The electrical resistance was measured with a two-point probe by painting two 1 cm silver contacts separated by 1 centimeter onto the surface of the experimental glass composite catalyst electrode.

### Example 2

In order to decrease electrical resistance, electroless platinum deposition using a modified Leaman plating bath was carried out on experimental glass composite catalyst electrodes produced as described in Experiment 1. The composition of the Leaman plating bath is presented in Table I. The reaction was conducted at a temperature of 70±0.2° C. The experimental glass composite catalyst electrodes were immersed in the Leaman plating bath for various times ranging from 15 seconds to 1800 seconds.

TABLE 1

| | Concentration |
|---|---|
| Component | (g/L) |
| H₂PtCl₆ | 4.0 |
| HCl | 33.0 |
| 5, sulfosalicylic acid hydrate | 2.0 |
| Sodium benzene 1,3 disulfonate | 1.0 |
| Sodium 1,3,6 napthalene trisulfate tribasic hydrate | 0.5 |
| Hydrazine dihydrochloride | 2.0 |

Experimental Results of Example 2:

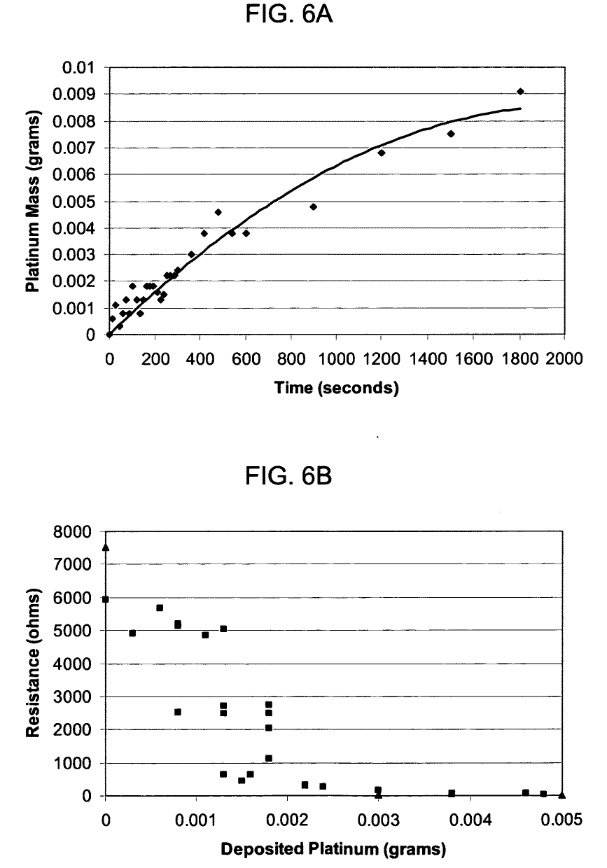

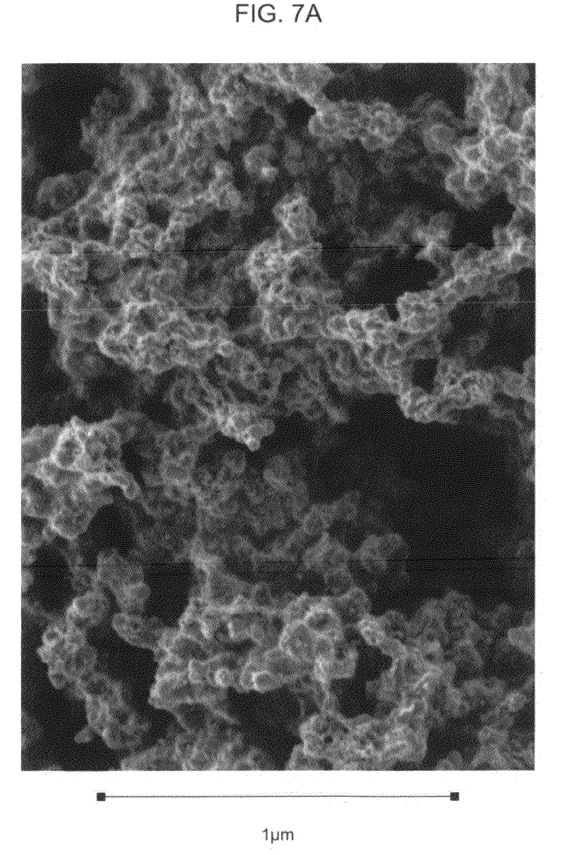

During the Leaman plating bath, the mass of deposited platinum and sheet resistance for various deposition times was monitored. FIG. 6A shows experimental results of time in a plating bath versus the deposited mass of platinum per square centimeter. Increased time in the aqueous plating bath led to increased deposition of platinum.

FIG. 6B shows a plot of the deposited mass of platinum per square centimeter on experimental glass composite catalyst electrodes versus electrical resistance per centimeter. As illustrated, as the mass of deposited platinum increased, the electrical resistance decreased. The electrical resistance of the experimental glass composite catalyst electrodes was measured with a two-point probe by painting two 1 centimeter silver contacts onto the surface, separated by 1 centimeter. As illustrated in FIG. 6B, the electrical resistance decreased dramatically where approximately 2 milligrams of platinum was deposited per square centimeter.

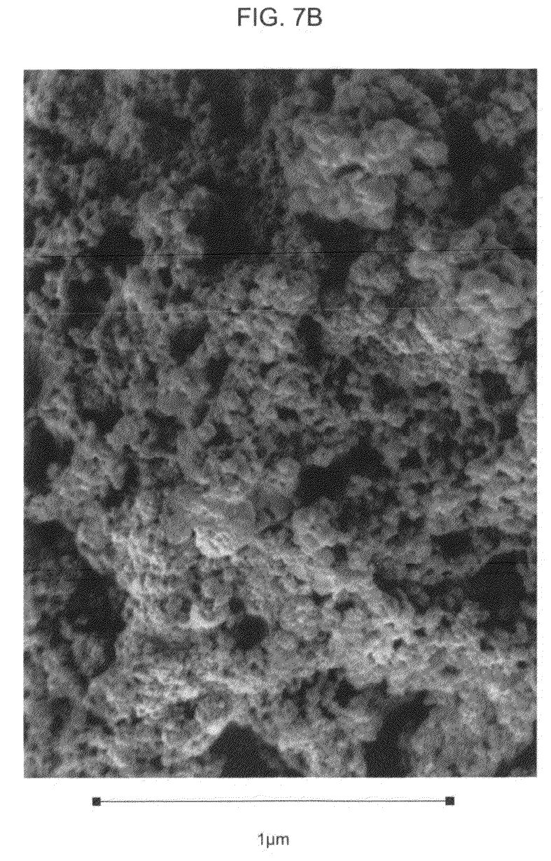

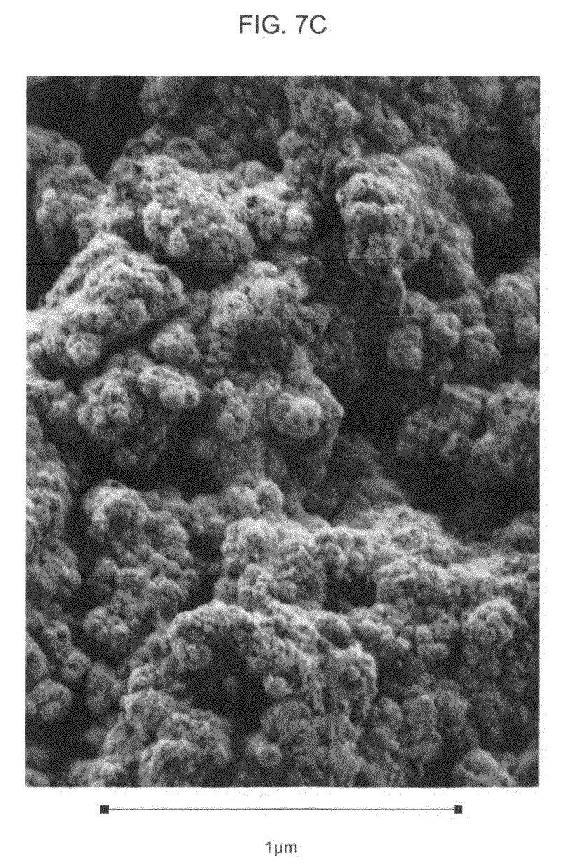

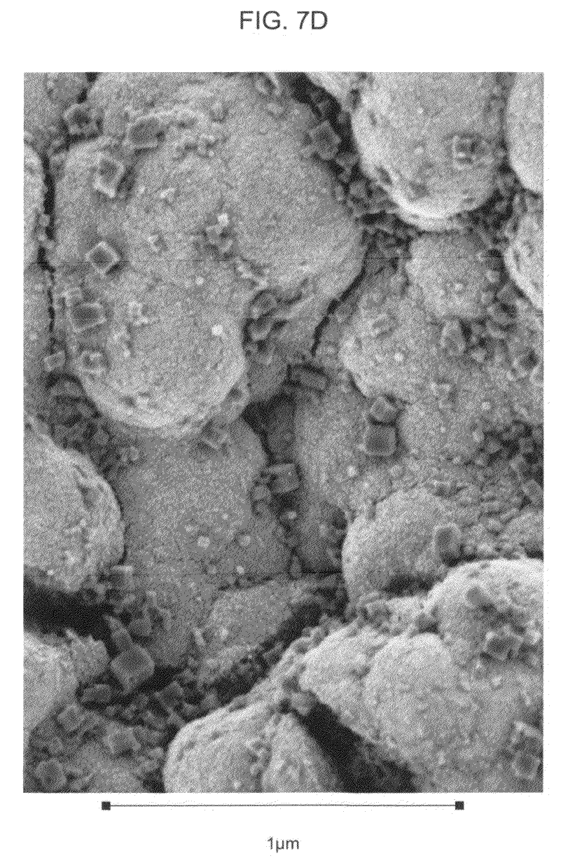

FIGS. 7A-7D show the evolution of the platinum structure at different times in the plating bath. FIG. 7A shows an experimental glass composite catalyst electrode prior to the electroless deposition of platinum. Prior to electroless deposition of platinum, most of the platinum nanoparticles have diameters of approximately 5 nanometers. The average pore is approximately 150 nanometers.

FIG. 7B shows an experimental glass composite catalyst electrode exposed to the electroless plating bath for 180 seconds. After 180 seconds in the plating bath, the platinum nanoparticles have grown to approximately an average diameter of 20 nanometers, with some nanoparticles as large as 50 nanometers. The average pore size has decreased to approximately 100 nanometers. The electrical resistance of the glass matrix film, shown in FIG. 7B, is approximately 3,000Ω per centimeter, and approximately 0.5 milligrams per square centimeter of platinum has been deposited.

FIG. 7C shows an experimental glass composite catalyst electrode exposed to the electroless plating bath for 300 seconds. The platinum nanoparticles have grown to an average diameter of 50 nanometers, with some having diameters as large as 100 nanometers. The average pore size has been reduced to 80 nanometers. The electrical resistance of the glass matrix film, shown in FIG. 7C, is approximately 100 Ω per centimeter, and approximately 2 milligrams per square centimeter of platinum has been deposited.

FIG. 7D shows an experimental glass composite catalyst electrode exposed to the electroless plating bath for 1800 seconds. The platinum nanoparticles are on the order of 1 micrometer and the pores have closed. Approximately 9 milligrams per square centimeter of platinum has been deposited.

The experimental glass composite catalyst electrode shown in FIG. 7C exhibits desirable characteristics (e.g. low electrical resistance and high porosity) and was selected for ex situ experimental evaluation.

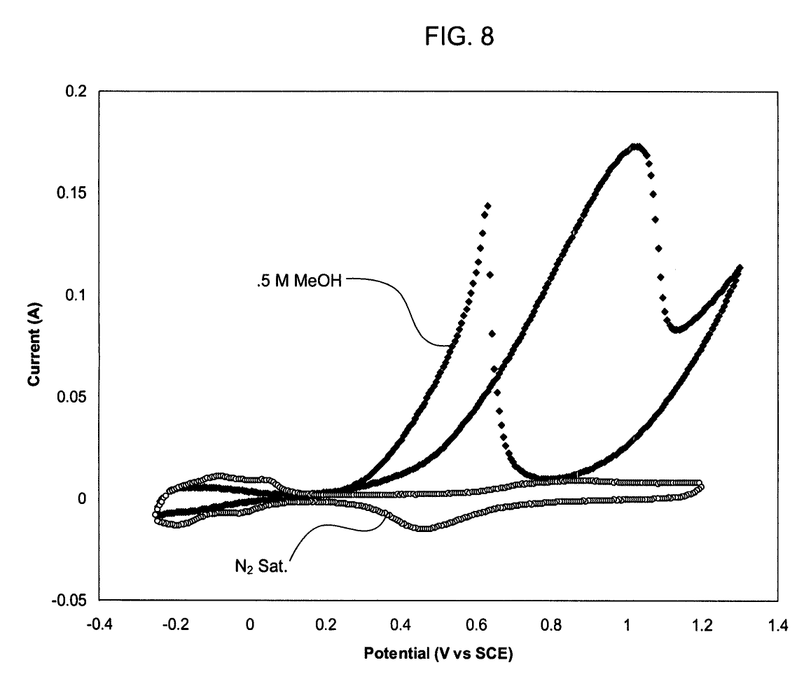

FIG. 8 shows an ex situ cyclic voltammetry (CV) performed on the experimental glass composite catalyst electrode shown in FIG. 7C, performed in 0.5 M H₂SO₄ and 0.5 M MeOH, at room temperature before and after the addition of methanol. The experimental glass composite catalyst electrode had a surface area of 1 square centimeter and the scan proceeded at 50 mV per second. The high oxidation peak current on the positive-going scan shows that the experimental glass composite catalyst electrode is highly active for methanol oxidation. The peak current is more than two orders of magnitude higher than a planar platinum foil electrode under similar conditions. See R. Liu, K. Triantafillou, L. Liu, C. Pu, C. Smith, and E. S. Smotkin, 144 J. OF THE ELECTROCHEMICAL SOC. L148 (1997).

The electrochemically active catalyst area of the experimental glass composite catalyst electrode was quantified using both the H_{upd} and ferrocyanide couple methods, yielding surface roughness values of 96 and 88, respectively. These results show that the surface area of the deposited platinum is high and that the pores are accessible to the solution. As illustrated in FIG. 8, the current increases at approximately 0.4 V versus NHE, as expected, although the peak potential is 200 mV more positive than expected. The higher peak potential is likely due to mass transport of methanol to the electrode surface and carbon dioxide transport in the pores away from the electrode surface when compared to a planar platinum foil electrode under similar conditions. See id. The mass transport effect is also seen in the sharp peak on the reverse scan at 0.5 V versus SCE, where the remaining reaction intermediates are oxidized and must desorb and escape through the porous glass matrix.

Although the CV results show a high platinum surface area, they do not reflect the degree of proton exchange between the catalyst and the PEM. The counter electrode used in the CV experiment is in the same high conductivity liquid electrolyte as the experimental glass composite catalyst electrode.

In order to evaluate the in situ performance of the experimental glass composite catalyst electrode in a fuel cell and compare it to a conventional Nafion-based anode, four types of cells (two half cells and two full cells) were prepared. All samples used a 1 millimeter thick, 2.0 square centimeter area, Nafion-impregnated porous glass frit as the substrate and primary electrolyte. The half cells were made by painting either conventional carbon supported platinum nanoparticles in a Nafion ink onto the anode side or applying the platinum catalyst, as shown in FIG. 7C, onto the PEM. The conventional anode and cathode catalyst inks were made with 40 percent by weight carbon supported platinum nanoparticles and contained 15 percent by weight Nafion solids after drying.

The counter and working electrode were placed in a two-compartment cell with a 0.5 M H₂SO₄ electrolyte in both compartments. The anode catalyst layer was used as the working electrode contact, and a platinum counter electrode was placed in the second compartment on the opposite side of the membrane. AC impedance spectroscopy was used to determine the contribution of the catalyst layer to the ionic impedance. The conventional Nafion electrode showed an ionic resistance of 52.8Ω. The sample with the glass composite catalyst electrode showed a high-frequency (1 MHz) intercept of 63.3Ω. This indicates that the ionic resistance of the composite catalyst layer is approximately 10.5Ω. For the 2.0 square centimeter area and 2 μm glass matrix film thickness the ionic conductivity of 10⁻⁵ S/cm is similar to the previously reported value for glass deposited by plasma enhanced chemical vapor deposition. See D. Bhusari, J. Li, P. J. Jayachandran, C. Moore, and P. A. Kohl, “Development of P-doped SiO₂ as proton exchange membrane for microfuel cells,” 8 J. OF THE ELECTROCHEMICAL SOC. A588 (2005); J. Li, C. W. Moore, D. Bhusari, S. Prakash, and P. A. Kohl, “Microfabricated fuel cell with composite glass/nafion proton exchange membrane,” 153 J. OF THE ELECTROCHEMICAL SOC. A343 (2006). Although the ionic conductivity value of the glass composite catalyst electrode is nearly four orders of magnitude lower than the value reported for Nafion, the relative thickness of the layer and the low operating current density mitigate the energy loss. See Replacing the battery in portable electronics (fuel cells), C. K. Dyer, 281 SCI. AM. 88 (1999); Design and testing of a passive planar three-cell DMFC, W. Qian, D. P. Wilkinson, J. Shen, H. Wang, and J. Zhang, 154 J. POWER SOURCES 202 (2006).

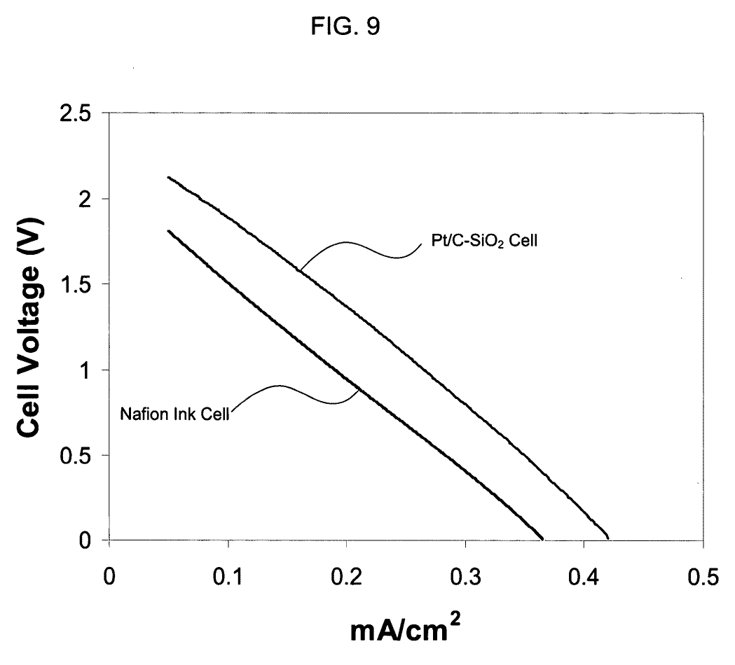

Full DMFCs were constructed by the same method as the half cells with respect to the electrolyte preparation and anode deposition. In both cases, conventional carbon supported platinum nanoparticles in Nafion ink were painted on the cathode side and cured at 150° C. DMFC polarization curves for both the conventional Nafion based anode and glass composite catalyst electrode are shown in FIG. 9. The polarization curves were taken at 23° C. using 10 M aqueous methanol fuel. The results show that the glass composite catalyst electrode has high activity as a DMFC anode. Further improvement may be expected by using a platinum-ruthenium alloy as a catalyst.

The performance of the fuel cell comprising the glass composite catalyst is improved over the fuel cell comprising the conventional anode, as shown by the 50 mV positive shift in the open-circuit voltage and increased current density. The improved performance may be due to a decrease in methanol permeation through the glass composite catalyst electrode, compared to the Nafion catalyst layer. The electrolessly deposited platinum may partially block the methanol access to the membrane and accordingly may reduce methanol crossover.

It should be emphasized that the described embodiments of this disclosure are merely possible examples of implementations and are set forth for a clear understanding of the principles of this disclosure. Many variations and modifications may be made to the described embodiments of this disclosure without departing substantially from the spirit and principles of this disclosure. All such modifications and variations are intended to be included herein within the scope of this disclosure and protected by the following claims.

1. A glass composite catalyst electrode for a fuel cell comprising:
an ionically conductive glass matrix;
a plurality of metal particles incorporated in the glass matrix, the metal particles operable to catalyze reactions in the fuel cell;
an electrically conductive layer disposed on the glass matrix.

2. The glass composite catalyst electrode of claim 1, wherein the electrically conductive layer comprises a metal operable to catalyze reactions in the fuel cell.

3. The glass composite catalyst electrode of claim 1, wherein the metal particles comprise platinum.

4. The glass composite catalyst electrode of claim 1, wherein the metal particles comprise platinum-ruthenium alloy.

5. The glass composite catalyst electrode of claim 1, wherein the glass matrix is doped with phosphorous.

6. The glass composite catalyst electrode of claim 5, wherein the silicon-phosphorus atomic ratio in the glass matrix is between about 100 to 1 and about 20 to 1.

7. The glass composite catalyst electrode of claim 1, wherein the proton conductivity of the glass matrix is greater than 10⁻⁴ S per centimeter.

8. The glass composite catalyst electrode of claim 1, wherein the electrical resistance of the electrically conductive layer is less than 300Ω per centimeter.

9. The glass composite catalyst electrode of claim 1, wherein the electrically conductive layer comprises between 2 milligrams of platinum per square centimeter and 5 milligrams of platinum per square centimeter.

10. The glass composite catalyst electrode of claim 1, wherein the glass matrix is porous.

11. The glass composite catalyst electrode of claim 1, wherein the plurality of metal particles are uniformly distributed throughout the glass matrix.

12. A method for composing a glass composite catalyst electrode for a fuel cell, the method comprising:
reacting a silicon precursor and water in a sol-gel type hydrolysis in the presence of metal particles to form an ionically conductive glass matrix incorporating the metal particles;
depositing the glass matrix on a substrate; and
subjecting the glass matrix to at least one curing step.

13. The method of claim 12, wherein the silicon precursor is tetraethyl orthosilicate.

14. The method of claim 12, wherein the metal particles comprise platinum.

15. The method of claim 12, wherein the metal particles comprise platinum-ruthenium alloy.

16. The method of claim 12, further comprising:
depositing a layer of electrically conductive material on the glass matrix.

17. The method of claim 16, wherein the conductive material is operable to catalyze reactions in the fuel cell.

18. The method of claim 16, wherein the layer of electrically conductive material has an electrical resistance of less than 300Ω per centimeter.

19. The method of claim 16, wherein the electrically conductive layer comprises between 2 milligrams of platinum per square centimeter and 5 milligrams of platinum per square centimeter.

20. The method of claim 12, wherein the layer of electrically conductive material is deposited in an aqueous plating bath.

21. The method of claim 12, further comprising:
reacting the silicon precursor and water in the presence of phosphorus.

22. The method of claim 21, wherein the silicon-phosphorus atomic ratio in the glass matrix is between about 100 to 1 and about 20 to 1.

23. The method of claim 12, wherein the proton conductivity of the glass matrix is greater than 10⁻⁴ S per centimeter.

24. The method of claim 12, wherein the glass matrix is porous.

25. The method of claim 12, wherein the plurality of metal particles are uniformly distributed throughout the glass matrix.

26. A fuel cell comprising:
a proton exchange membrane;
an electrode;
a glass composite catalyst electrode comprising:
an ionically conductive glass matrix,
a plurality of metal particles incorporated in the glass matrix, the metal particles operable to catalyze reactions in the fuel cell, and
an electrically conductive layer disposed on the glass matrix; and
wherein the proton exchange membrane is disposed between the glass composite catalyst electrode and the electrode.
